(19) United States
(12) Patent Application Publication
(10) Pub. No.: US 2011/0003225 A1
(43) Pub. Date: Jan. 6, 2011

(54) RECHARGING VALVE FOR A FUEL CELL

(75) Inventor: Steven J. Eickhoff, Brooklyn Park, MN (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/828,077

(22) Filed: Jun. 30, 2010

Related U.S. Application Data
(60) Provisional application No. 61/223,316, filed on Jul. 6, 2009.

(51) Int. Cl. H01M 8/04; H01M 8/22

(52) U.S. Cl. 429/443; 429/513; 429/502; 429/504

(57) ABSTRACT

The present invention relates to a recharging valve for an electrical power generator. The electrical power generator includes one or more fuel cells, a housing, surrounding the one or more fuel cells, a sleeve contacting at least a portion of an outer surface of the housing, a fuel chamber enclosing a hydrogen generating fuel, and one or more recharging valves, in contact with the fuel chamber. The recharging valves provide a means for safe and rapid recharging the hydrogen generating fuel.

### RELATED APPLICATIONS

This application claims the benefit of U.S. Provisional Patent Application 61/223,316 filed Jul. 6, 2009, entitled “POWER GENERATION UTILIZING FUEL CELL” the contents of which application is incorporated herein by reference in its entirety.

### BACKGROUND

1. Field of Invention

This invention relates to fuel recharging valves for recharging metal hydride fuel cells.

2. Background

Fuel cells, such as PEM fuel cells, use a simple chemical reaction to combine hydrogen and oxygen into water, producing electric current in the process. Hydrogen may be produced by a chemical reaction between a fuel, such as lithium aluminum hydride, and water vapor or by absorption/desorption-adsorption/desorption of hydrogen from a metal hydride. At an anode, hydrogen molecules are ionized by a platinum catalyst, and give up electrons. The proton exchange membrane (PEM) allows protons but not electrons to flow through the membrane. As a result, hydrogen ions flow through the PEM to a cathode, while electrons flow through an external circuit. As the electrons travel through the external circuit, they can perform useful work by powering an electrical device such as an electric motor, light bulb or electronic circuitry. At the cathode, the electrons and hydrogen ions combine with oxygen to form water. The byproducts of the reaction are water and heat.

A problem encountered in using metal hydride in fuel cells is recharging hydrogen into the hydrogen storage chamber of the fuel cell. Air must not be permitted to enter the hydrogen storage chamber because the metals used to form metal hydrides are reactive to the oxygen in air, causing corrosion and loss in hydrogen capacity. Oxygen may also react with any residual hydrogen in the metal hydride, potentially causing an explosion or fire.

### SUMMARY

In one embodiment, the invention provides an electrical power generator including one or more fuel cells, a housing surrounding the one or more fuel cells, a sleeve contacting at least a portion of an outer surface of the housing, a fuel chamber enclosing a hydrogen generating fuel; and one or more recharging valves in contact with the fuel chamber.

In one embodiment, the invention provides a method for recharging an electrical power generator. The method includes coupling a recharging valve in the electrical power generator that is in communication with a metal hydride to a hydrogen recharger, evacuating the electrical power generator using the hydrogen recharger, recharging the electrical power generator with hydrogen from the hydrogen recharger, measuring the pressure in the electrical power generator, stopping the recharging when the pressure reaches a predetermined threshold in the electrical power generator, and disconnecting the coupled recharging valve from the hydrogen recharger.

In one embodiment, the invention provides a recharging valve for recharging a hydrogen fuel chamber, enclosing a hydrogen generating fuel. The recharging valve includes a valve stem in a valve seat actuated or assisted by one or more springs, and compression members surrounding the recharging valve and capable of forming a seal between the valve stem and the valve seat.

### BRIEF DESCRIPTION OF THE DRAWINGS

FIG. 1 illustrates a cross-sectional schematic representation of an electrical power generator of the invention having a recharging valve for recharging the fuel, according to some embodiments.

FIG. 2 illustrates a rechargeable electrical power generator in the shape of an “AA” battery form factor.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

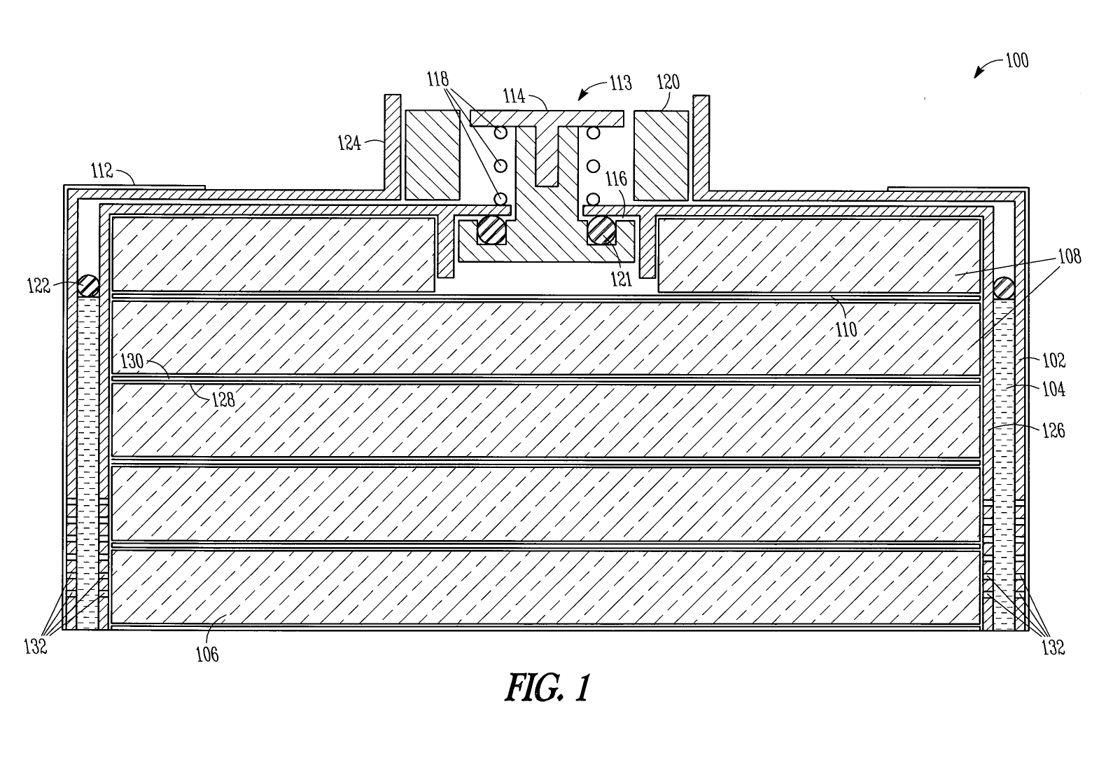

FIG. 1 illustrates a cross-sectional schematic representation of an electrical power generator of the invention having a non-electrically conductive sleeve, according to some embodiments. As seen in FIG. 1, an electrical power generator 100 includes a housing 102, at least one fuel cell 104 mounted within the housing 102, at least one fuel chamber 106 for storing a fuel storage substance 108 mounted with the housing 102. The fuel substance 108 may be a metal hydride fuel pellet and be separated by porous spacers 110, for example. Fuel cell 104 generates electricity and fuel cell water from the reaction of hydrogen gas and oxygen gas from the air.

The housing 102 may be surrounded by a non-conductive oxygen and water vapor permeable sleeve 112. The sleeve 112 may surround perforated regions 132 of the housing 102. Sleeve 112 allows oxygen and water vapor to permeate freely but prevents liquids like water from entering the fuel cell. In one embodiment the sleeve is made from expanded polytetrafluoroethylene (PTFE).

A recharging valve 113 is positioned between the hydrogen generating fuel and ambient to allow recharging of the fuel upon insertion of the recharging valve into a hydrogen recharger. Recharging valve 113 may optionally have a cap or a cover to prevent contamination when not in use. The recharging valve 113 comprises a valve stem 114 and a valve seat 116 that may be actuated or assisted by one or more springs 118. A compression member 120, such as a compressable gasket, may surround valve stem 114. Compression members may be gaskets or O-rings, for example compressable gasket 120 and O-ring 121, and function as sealing members to seal valve seat 116. The generator 100 includes a cathode electrode 124 and anode electrode 126. The recharging valve 113 may act as a refill valve or resealable refuling port, for example. The dimensions of the generator 100 may be consistent with the size of conventional batteries such as “AA”, “AAA”, “C”, and “D” alkaline batteries, for example. Similarly, the dimensions of the component parts of the recharging valve may be very small in scale but may vary with respect to the particular application of the recharging valve, such as use for recharging electrical power generators the size of conventional “AA”, “AAA”, “C”, and “D” batteries. In operation, recharging valve 113 of an electrical power generator in which the hydrogen is depleted is connected to a hydrogen recharger (not shown). In one embodiment, the recharger is one described in Applicant's copending and commonly assigned U.S. Ser. No. 12/722,388 (filed Mar. 10, 2010 by S. J. Eickhoff, and entitled “Recharger for Fuel Cells”), and incorporated herein by reference.

In operation, a simple charging process may be performed by a combination of human interactions and a recharger. One or more electrical power generators may be inserted such that they are coupled to the manifold of the recharger through recharging valve 113 in a sealed manner. A pin in the hydrogen recharger pushes on valve stem 114, compresses spring 118, and breaks the seal between O-ring 121 and anode electrode 126, thereby opening recharging valve 113. Gasket 120 is compressed by a ring on the hydrogen recharger and forms a gas seal between the hydrogen recharger and anode electrode 126, while O-ring 121 forms a seal between valve seat 116 and anode electrode 126.

A vacuum pump may be used to evacuate the recharger manifold and electrical power generator to remove contaminant gases such as water vapor or oxygen from the electrical power generator. Various valves in the recharger may be controlled in a manner to facilitate such evacuation. In one embodiment, a pressure sensor may be used to determine if one or more electrical power generators has failed, or if the recharger is otherwise leaking. The electrical power generators may be individually tested for leaks in a further embodiment using the valves within the recharger to isolate them. After evacuation of the electrical power generator and testing, hydrogen is pumped into one or more electrical power generators and the fuel storage substance absorbs the hydrogen. The electrical power generator may be held by a heat sink during recharging to remove the heat generated during refueling, resulting in a more rapid refueling. Upon completion of charging, the cell may be removed and valve stem 114 automatically seats into valve seat 116 sealing valve 113.

The valve stem 114 may be manufactured from metals such as nickel plated steel or stainless steel.

The valve seat 116 may be manufactured from metals such as nickel plated steel or stainless steel.

Gasket 120 and and O-ring 121 may be manufactured from a range of polymers that are compatible with hydrogen, such as butyl rubber.

Metal hydride 108 may be chosen as a fuel substance for the fuel storage substance 108. In one embodiment one or more metal hydrides may be chosen such that its equilibrium pressure is in the range of approximately 0.01 to 10 atmospheres over an approximately −20 to 60° C. temperature range. Potential metal hydrides include ab5, ab2, ab materials, complex alloys, intermetallic compounds or solid solution alloys. Specific materials include but are not limited to LaNi₅, LaNi₄.6Mn_{0.4}, MnNi_{3.5}Co_{0.7}Al_{0.8}, MnNi₄.2Co_{0.2}Mn_{0.3}Al_{0.3}, TiFe_{0.8}Ni_{0.2}, CaNi₅, (V_{0.9}Ti_{0.1})_{0.95}Fe_{0.05}, (V_{0.9}Ti_{0.1})_{0.95}Fe_{0.05}, and LaNi_{4.7}Al_{0.3}. Mixtures of these materials may be used if desired.

In one embodiment, an AB5 type material such as LaNi5, or alloys containing other metals such as aluminum or tin may be used as the reversible metal hydride. The other alloys such as aluminum or tin may be used to tailor the pressure-temperature characteristics of the fuel so that the equilibrium hydrogen pressure at room temperature, approximately 20° C. is in the range of 0.1 PSI up to about 100 PSI or higher. In one embodiment, the pressure ranges up to about 10 PSI to avoid high rates of hydrogen leakage to ambient. Some applications may use even higher pressure with stronger containers. A higher fraction of aluminum or tin results in lower pressure equilibrium.

The metal hydride fuel storage material may be encapsulated using any suitable method which would be appropriate for the chosen encapsulation material, such as wrapping, coating and the like. Such methods are described in, for example in commonly assigned, U.S. Patent Application Publication 2009/0117442 (Eickhoff) that is incorporated herein by reference. In one embodiment, the encapsulation material comprises a hydrogen permeable, liquid water impermeable membrane 128 such as expanded polytetrafluoroethylene (PTFE).

In one embodiment, the metal hydride fuel storage material 108 is in the form of solid pellets and are approximately 20% porous. The porosity may be varied to control volume expansion and hydrogen generation rate. Multiple pellet segments 108 may be stacked vertically to provide a cylindrical pellet with larger height. The height of the individual segments may also be varied to increase the pellet surface area, which may also increase the hydrogen generation rate.

In one embodiment, fuel chamber 106 includes multiple metal hydride fuel pellets 108 stacked in a vertical relationship. A hydrogen permeable membrane 128 may optionally be disposed about the fuel pellet segments, which may be cylindrical in shape. The membrane 128 may extend over the ends of the stack of fuel pellets in some embodiments. An air gap 130 may be provided between the membrane 128 and fuel pellet 108 if desired.

A bore may be formed in the fuel pellet in one embodiment. The bore may extend through one or more segments, or may extend partially through one or more segments. In one embodiment, the bore is concentric with the axis of the fuel pellet, but may also be parallel, or transverse to the axis or at any angle there-between. The bore may provide room for expansion of the fuel pellet under varying time and environmental conditions, and allow hydrogen to diffuse axially during discharge or recharge.

The electrical power generator is self regulating based on the pressure and electrical demand. As electrical demand increases, hydrogen is consumed to produce the electricity needed by a load. As the hydrogen is consumed, pressure within the fuel chamber 106 drops, resulting in the release of more hydrogen. As the electrical demand of the load decreases, less hydrogen is consumed, resulting in an increase in pressure, and preventing the further release of hydrogen from fuel 108. The hydrogen release rate can be very fast, limited only by the rate at which heat can be transferred to the fuel. In this manner, the electrical power generator may provide bursts of power, without great deviation in pressure. The operating temperature may affect the equilibrium pressure within the cell, as the pressure varies with temperature.

The electrical power generator 100 may be maintained at an operating temperature of from about −40° C. to about 85° C., from about −20° C. to about 50° C., from about 0° C. to about 50° C. and from about 20° C. to about 50° C. while in use, for example.

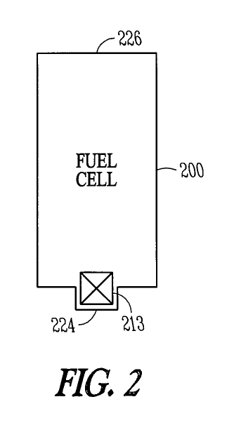

FIG. 2 illustrates a rechargeable electrical power generator 200 in the shape of an AA battery form factor, having a cathode 224 and an anode 226. In one embodiment, the cathode 224 end of the fuel cell 200 includes a recharging valve 213. Upon inserting of the electrical power generator into a recharger, the recharging valve 213 mates with the manifold of the recharger, causing the recharging valve 213 to open and allow evacuation, testing, and hydrogen recharging of electrical power generator 200.

While the present invention has been particularly shown and described with reference to many embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. An electrical power generator comprising:
one or more fuel cells;
a housing, surrounding the one or more fuel cells;
a fuel chamber enclosing a hydrogen generating fuel; and
one or more recharging valves in contact with the fuel chamber.

2. The electrical power generator of claim 1, further comprising a cathode electrode positioned near one or more recharging valve.

3. The electrical power generator of claim 1, wherein the fuel chamber further includes one or more porous spacers.

4. The electrical power generator of claim 1, wherein the fuel comprises a metal hydride.

5. The electrical power generator of claim 1, further comprising a sleeve contacting at least a portion of an outer surface of the housing.

6. The electrical power generator of claim 4, wherein the metal hydride comprises ab5, ab2, or ab materials, complex alloys, intermetallic compounds or solid solution alloys.

7. The electrical power generator of claim 4, wherein the metal hydride comprises LaNi₅, LaNi₄.6Mn_{0.4}, MnNi_{3.5}Co_{0.7}Al_{0.8}, MnNi₄.2Co_{0.2}Mn_{0.3}Al_{0.3}, TiFe_{0.8}Ni_{0.2}, CaNi₅, (V_{0.9}Ti_{0.1})_{0.95}Fe_{0.05}, (V_{0.9}Ti_{0.1})_{0.95}Fe_{0.05}, and LaNi_{4.7}Al_{0.3}.

8. The electrical power generator of claim 5 wherein the ab5 material comprises LaNi5, LaNi_{4.7}Al_{0.3}, LaNi_{4.6}Al_{0.4}

9. The electrical power generator of claim 5 wherein the sleeve comprises an oxygen permeable membrane.

10. The electrical power generator of claim 9, wherein the oxygen permeable membrane comprises expanded polytetrafluoroethylene (PTFE).

11. The electrical power generator of claim 1, wherein the recharging valve comprises a valve stem in a valve seat actuated or assisted by one or more springs; and compression members surrounding the recharging valve and capable of forming a seal between the valve stem and the valve seat;
such that attachment to a hydrogen recharger compresses the one or more springs, and breaks the seal between the O-ring and anode electrode, thereby opening the recharging valve.

12. The electrical power generator of claim 11, wherein the compression member is a compressable gasket and/or an O-ring.

13. The electrical power generator of claim 11, wherein the valve stem is manufactured of steel.

14. The electrical power generator of claim 11, wherein the valve seat is manufactured of steel.

15. The electrical power generator of claim 1 having the dimensions of an “AA” “AAA”, “C”, or “D” alkaline battery.

16. A method for recharging an electrical power generator comprising:
coupling a valve in the electrical power generator that is in communication with a metal hydride to a hydrogen recharger;
evacuating the electrical power generator using the hydrogen recharger;
recharging the electrical power generator with hydrogen from the hydrogen recharger;
measuring the pressure in the electrical power generator;
stopping the recharging when the pressure reaches a predetermined threshold in the electrical power generator; and
disconnecting the coupled recharging valve from the hydrogen recharger.

17. A recharging valve for recharging a hydrogen fuel chamber, enclosing a hydrogen generating fuel comprising:
a valve stem in a valve seat actuated or assisted by one or more springs;
compression members surrounding the recharging valve and capable of forming a seal between the valve stem and the valve seat.

18. The recharging valve of claim 17 such that pushing upon the valve stem compresses the one or more springs, and opens the recharging valve.
